(19) United States
(12) Patent Application Publication
(10) Pub. No.: US 2010/0023748 A1
(43) Pub. Date: Jan. 28, 2010

(54) SELF CHECKING ENCRYPTION AND DECRYPTION BASED ON STATISTICAL SAMPLING

(75) Inventors: John Sui-Kei TANG, Costa Mesa, CA (US); Daming JIN, Costa Mesa, CA (US); Jim Donald BUTLER, Costa Mesa, CA (US); Jeff Junwei ZHENG, Costa Mesa, CA (US)

Correspondence Address: EMULEX DESIGN & MANUFACTURING CORPORATION;C/O MORRISON & FOERSTER LLP, 555 WEST FIFTH STREET, SUITE 3500, LOS ANGELES, CA, 90013, US

(73) Assignee: Emulex Design & Manufacturing Corporation, Costa Mesa, CA (US)

(21) Appl. No.: 11/966,890

(22) Filed: Dec. 28, 2007

(51) Int. Cl. H04L 9/00

(52) U.S. Cl. 713/150; 714/48; 714/E11.03

(57) ABSTRACT

The present invention is related to the checking of encryption. Embodiments of the present invention are based on the discovery that sufficiently high reliability may be established without checking every encryption block. Instead, embodiments of the present invention provide that data being encrypted may be sampled at certain rate (which may be constant or varying) and only the sampled data may be checked. In general, embodiments of the present inventions are applicable to a fast encryption circuit that may encrypt an entire stream of incoming data into a stream of encrypted data and one or more slower (or slow) encryption circuit and/or one or more slow decryption circuit that operate(s) only on selected samples of the incoming or encrypted data in order to check the encryption of the fast circuit. Thus, encryption can be verified without incurring the costs of exhaustively checking all encrypted data.

### FIELD OF THE INVENTION

This invention relates to encryption in general and more specifically to methods and systems for checking or verifying previously performed or ongoing encryption.

### BACKGROUND OF THE INVENTION

Modern computer systems and networks often utilize encryption to prevent unauthorized access to sensitive data. Most current systems that utilize encryption can be divided into two types. One is “data-in-flight” encryption. This type of encryption may provide that a first device encrypts some data, sends it to a second device over a network and the second device decrypts the data upon receipt. Thus, the data is encrypted while “in flight” (i.e. being transmitted over the network). Thus, data-in-flight encryption protects data from being improperly accessed or copied while traveling across a network. Another type of encryption is “data-at-rest” encryption. In this case, data may be encrypted and stored in its encrypted state for a significant amount of time. Thus, data-at-rest encryption provides protection from unauthorized copying of stored data. The cases where both data-in-flight and data-at-rest encryption are being used (i.e., when data is encrypted by a first device, sent to a second device over a network, and stored by the second device in its encrypted state without decrypting it upon receipt) are usually referred to as data-at-rest encryption.

Because encryption and decryption tend to be computationally intensive, they are often performed by specialized hardware instead of, or in addition to, software. For example, in some systems a host bus adapter (HBA) may perform encryption. An HBA may be a network adapter that performs various network related operations for a host it is a part of. Thus, an HBA may be used to offload network related processing from the host's main CPU (or other processing units), and thus speed up network communications. The host may be a computer (e.g., a personal computer, a server, a workstation) or another similar device (e.g., a RAID array, etc.) HBAs are used for several types of existing networks, such as Fibre Channel, Serial Attached SCSI (SAS), and others. Some HBAs may also perform encryption of data being sent over the network (and/or decryption of received data). Encrypted data may be sent over the network and decrypted by the recipient upon receipt (e.g., it may be decrypted by an HBA at a recipient device). Alternatively, the data may be sent over the network and stored by the recipient device in its encrypted state (i.e., data-at-rest encryption).

Errors in encryption are a significant concern in the industry. Error free encryption involves encrypting an original set of data to produce encrypted data and allowing another process to decrypt the data using predefined methods in order to obtain the original data. If there is an error in encryption the other process may not be able to obtain the original data, or can only obtain a corrupted version thereof. Thus, errors in encryption may result in actual loss of data.

Errors in encryption are of special concern for data-at-rest scenarios. In these cases encrypted data is stored, and that stored data may be (and often is) the only copy of the data available. Thus, any errors in encryption are likely to result in at least partial loss of data. Data-in-flight scenarios are also vulnerable. In such cases, the recipient may check the received data to determine if there are any errors and request another re-encrypted copy of the data (or selected portions thereof) if there are errors. However, in some cases, the recipient may not be able to do such a check as it may be difficult to ascertain whether there are any errors with the received data, or the sender may not be able to send additional copies (the sender may, for example, need to delete unencrypted data as soon as it encrypts it for security reasons).

Encryption errors may be caused by design errors in encryption software and/or hardware or by random errors which may occur even for error-free software and hardware designs. For example, external radiation (such as X-ray radiation) may hit one or more flip flops and cause them to change their state, thus causing an error.

There are various existing schemes for checking encryption. One is to perform encryption of all data to be encrypted by two or more different modules in parallel. Then, the results of the different modules can be compared to each other to determine whether there have been any errors. Another is to decrypt all encrypted data at the device that is performing the encryption and compare that with the original data being encrypted. If the comparison fails, then there must have been an error in encryption or decryption.

However, the existing methods are relatively computationally intensive. They usually require about the same amount of computation as the act of encryption. Thus, they may either require that the encryption process is significantly slowed down or that additional hardware be provided to check encryption (existing checking methods often require that the encryption hardware be doubled, which may result in a doubling of cost).

### SUMMARY OF THE INVENTION

The present invention is related to the checking of encryption. Embodiments of the present invention are based on the discovery that sufficiently high reliability may be established without checking every encryption block. Instead, embodiments of the present invention provide that data being encrypted may be sampled at certain rate (which may be constant or varying) and only the sampled data may be checked. In general, embodiments of the present inventions are applicable to a fast encryption circuit that may encrypt an entire stream of incoming data into a stream of encrypted data and one or more slower (or slow) encryption circuit and/or one or more slow decryption circuit that operate(s) only on selected samples of the incoming or encrypted data in order to check the encryption of the fast circuit. Thus, encryption can be verified without incurring the costs of exhaustively checking all encrypted data.

According to some embodiments the fast encryption circuit may be a pipelined circuit and the slow encryption and/or decryption circuits may be iterative circuits.

### BRIEF DESCRIPTION OF THE DRAWINGS

FIG. 1 is a diagram of an exemplary HBA according to some embodiments of the invention.

FIG. 2 is a conceptual diagram of an exemplary encryption engine according to some embodiments of the invention.

FIG. 3 is a timing diagram of an exemplary encryption checking system of some embodiments of the present invention.

FIG. 4 is a diagram of an exemplary encryption engine according to some embodiments of the invention.

### DETAILED DESCRIPTION OF EXEMPLARY EMBODIMENTS

In the following description of preferred embodiments, reference is made to the accompanying drawings which form a part hereof, and in which it is shown by way of illustration specific embodiments in which the invention may be practiced. It is to be understood that other embodiments may be utilized and structural changes may be made without departing from the scope of the preferred embodiments of the present invention.

Although embodiments of the present invention are described primarily in terms of HBAs and particular types of encryption algorithms, they are not thus limited. A person of skill in the art would recognize that embodiments of the present invention can be implemented in any types of network adapters (such as, e.g., HDAs, FCoE adapters, NICs), and any other types of encryption circuits and/or software that need not be related to network adapters or networking at all. Furthermore, embodiments of the present invention can be used in conjunction with various types of encryption protocols (including all block cipher protocols) and are not limited to the encryption protocols discussed herein.

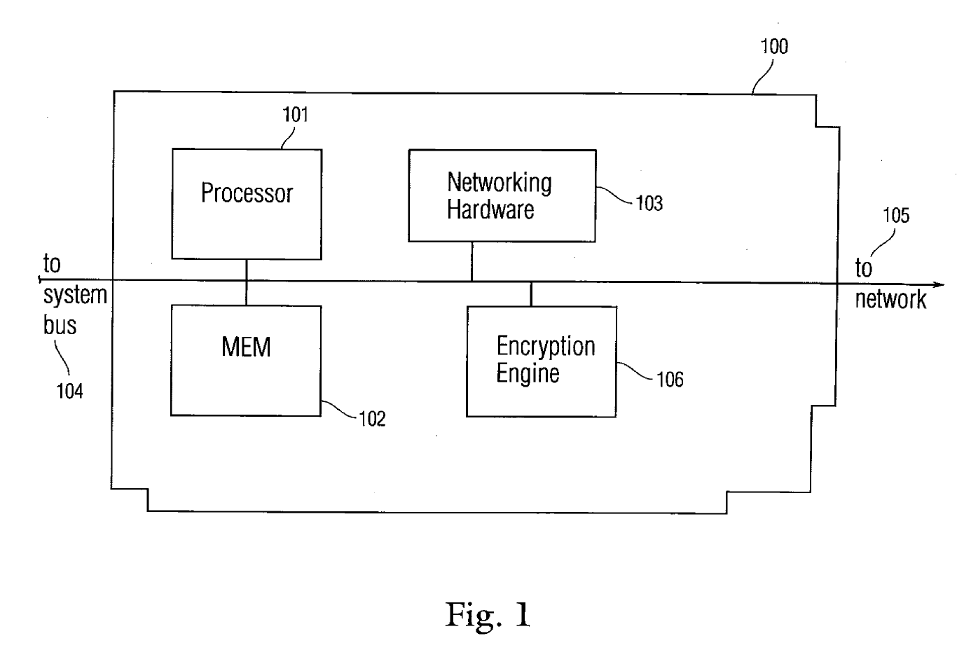

FIG. 1 is a diagram of an exemplary HBA 100 according to some embodiments of the invention. HBA 100 may include a processor 101 (such as, for example, an ARM processor) and a memory 102. The memory may include software for execution at the processor (also referred to as firmware) as well as various data. More specifically, the memory may include various data that has been received from the network and/or is being processed for sending over the network. The HBA may also include networking hardware 103 that may include various application specific hardware. The HBA may be connected to a system bus (connection 104) and to a network (connection 105). The system bus may connect the HBA to a host the HBA is a part of. The network may be a Fibre Channel network, a SAS network, an Ethernet network or another type of network. The processor and the networking hardware may together process data for transmission over the network and/or process received data from the network for sending over the bus.

Encryption engine 106 may be used for encryption. It may, for example, access data that is to be sent over the network from the memory 102, encrypt it and save it back to memory 102. The processor and the networking hardware may subsequently access the encrypted data from memory 102, perform additional processing needed to prepare the data for network transmission (i.e., splitting the data into frames, addressing the frames, etc.) and transmit the data. The encryption engine may encrypt data based on instructions from the processor. Some portions of the encryption process may be performed by the processor as a result of execution of firmware. The encryption engine may include tamper proof features. The encryption engine may also include decryption functionality and may be a decryption engine as well.

In some embodiments, elements 101-103 and 106 may be part of a first channel of a dual channel HBA. The HBA may include a second channel that is of a similar structure as the first one. The two channels may operate in parallel to ensure faster network processing. For example, one channel of the two channels can receive data and the other can send data. Some embodiments may feature an HBA with more than two channels.

In some embodiments, one channel may include encryption engine 106 and the other may include decryption engine instead. The channel including the encryption engine may be used primarily for sending data, while that including the decryption engine may be used primarily for receiving data. In some embodiments, both the encryption and decryption engine may be able to perform the opposite function (i.e., the encryption engine may be able to decrypt, while the decryption engine may be able to encrypt), but at a lower speed.

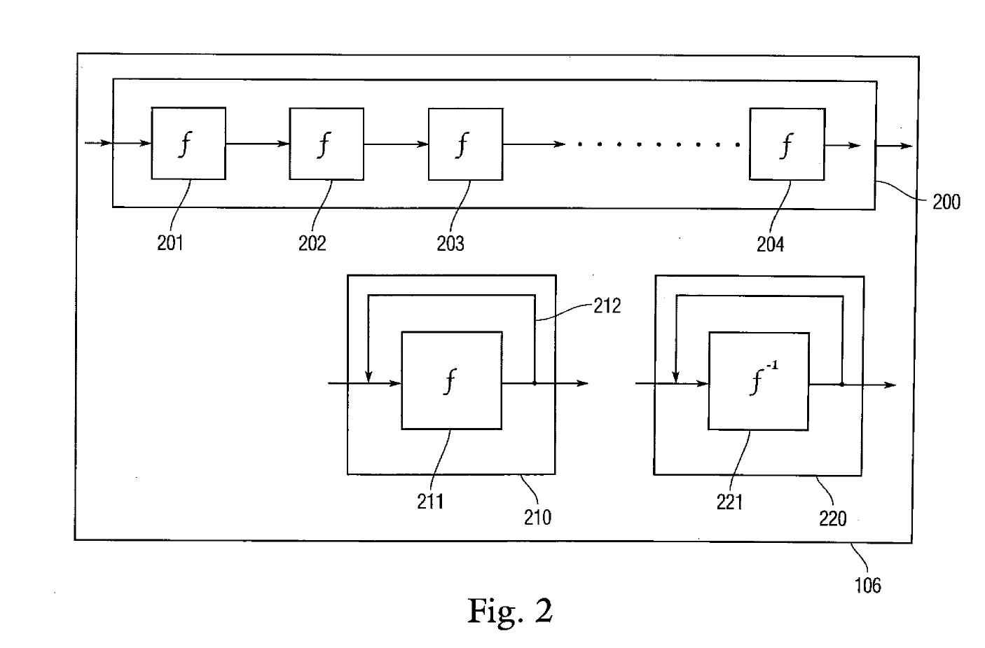

FIG. 2 is a conceptual diagram of an exemplary encryption engine according to embodiments of the present invention. The encryption engine may be designed to perform encryption according to various known encryption standards, including but not limited to the Advanced Encryption Standard (AES) family of standards, including AES_GCM, AES_XTS, AES_CBC, AES_CTR, AES key wrap unwrap, and others including GMAC and CMAC, DES, etc.

The encryption engine 106 may include a pipeline encryption module 200 and an iterative encryption module 210. The pipeline encryption module may include a plurality of function elements 201-204. While only four function elements are chosen, more may be present. For example, 16 function elements may be present. Each function element may take in a block of data and transform it into another block of data based on a function associated with the function element. Each function element may also take in one or more parameters, in addition to the block of data. Each function element may be associated with the same function. In general, each block of data may include various amounts of data, from 1 bit to many gigabytes. Block sizes of 1 byte to 32 bytes are more common. Usually, all blocks within a stream of data are of the same size.

While FIG. 2 suggests that each function element takes in the unmodified output of the previous function element as its input, this need not be the case. A function element may take one or more additional parameters as its input. Furthermore, a previous function element's output may be modified (for example, by adding a “tweak” value as provided by some encryption standards) before being input into a current function element.

Thus, the pipeline module may take in an input, apply the function “f” to it multiple times at successive function elements and output the results (some additional operations, as discussed above may also be performed). This may result in encryption of the input.

The pipeline structure of the pipeline module may beneficially increase the throughput of the module. If a certain block of data is being processed in one function element (e.g., element 203) other blocks of data may be simultaneously processed in other elements (e.g., elements 201, 202, 204, etc.) Thus, if each element takes a single clock cycle to process a data block, according to known principles of pipelining, the pipeline module may take a relatively long time to process the first data block (e.g., 16 clock cycles, if there are 16 function elements) but may finish the processing of a single data block per cycle thereafter. This relatively high performance is provided at a cost of a relatively large size of the pipeline encryption module.

The encryption engine may also include another module—an iterative encryption module 210. The iterative module 210 may include a single function element 211. The function element may execute the same function as elements 201-204. The iterative encryption module may perform the same encryption operation (i.e., encrypt blocks of data according to the same encryption standard) as the pipelined encryption module. However, the iterative encryption module may use the same function element to perform the multiple functions necessary to encrypt a single data block. Thus, feedback path 212 may be used to return a result value to the input of the function element. Thus, the iterative module may apply the function “f” multiple times (e.g., 16) to a single data block in order to encrypt it (as was the case with the pipelined encryption module). However, in contrast to the pipelined module, the iterative encryption module uses the same function element multiple times to process a single data block and therefore cannot process multiple blocks at the same time. Thus, the iterative encryption module is significantly slower than the pipelined module, taking a number of clock cycles (e.g., 16) to encrypt each data block. However, the iterative encryption module is advantageous in being much smaller and thus much less costly (in terms of production costs and power dissipation) than the pipelined encryption module.

Existing HBAs may include encryption engines that include both an iterative and a pipelined encryption module. The pipelined module may be used for encrypting relatively large amounts of data, while the iterative encryption module may be used for quicker encryption related tasks, such as, for example, generating a tweak value for AES encryption. Furthermore, existing devices may use the iterative encryption module to encrypt data in parallel with the pipelined module. Thus, if a certain set of data needs to be encrypted, the pipelined module may encrypt the majority of it, however, the iterative module may encrypt some of it (e.g., 1/17^{th}), thus contributing a small improvement to the overall throughput. However, in some existing systems, the iterative encryption module may not be used at all when the pipelined module is encrypting a set of data.

The encryption engine may also include an iterative decryption module 220. The iterative decryption module may include a single function element that performs a function inverse to the function performed by modules 201-204, 211 (i.e., function “f⁻¹”). Like the iterative encryption module, the iterative decryption module may perform the function multiple times on the same block of data in order to decrypt the block of data. Existing HBAs may feature encryption engines that include an iterative decrypt module for various reasons—e.g., to decrypt keys, or to provide additional flexibility by giving the module some rudimentary, albeit relatively slow, decryption capability. As noted above, an HBA may include two channels, one of which including the above described encryption engine, and the other including a decryption engine. While it may be assumed that the channel including the encryption module may be used primarily for sending data (and thus for encryption), it may be preferable to provide it with some decryption capability in order to improve the flexibility of the HBA.

The iterative encryption and decryption modules are relatively small, and thus less costly. Thus, for the current example of a 16 stage pipeline encryption module, the iterative modules may be one tenth of the size of the pipelined one.

Existing HBAs which include encryption checking technology usually provide that every encrypted byte should be checked. Thus, these devices usually feature an encryption checking module that is about as computationally fast as the module performing the encryption. If pipelined encryption module 200 is performing the encryption, then existing encryption checking philosophy would require that another module of similar computational power perform decryption. This may be another pipelined encryption module similar or identical to module 200 that encrypts the same inputs as module 200 and checks the results. As noted above, a module of the type of module 200 may be relatively costly due to its comparatively large size.

Alternatively, a decryption module that decrypts the results of module 200 and checks them against its inputs (which may have been previously stored) may be used for encryption checking. Since existing encryption checking philosophy assumes that every encrypted block should be checked, the decryption module may need to be as fast as module 200 and thus may need to be a relatively large and expensive pipelined decryption module. Thus, as noted above, existing encryption verification technology is relatively costly (both in terms of production costs and power usage).

Embodiments of the present invention are based on the discovery that sufficiently high reliability may be established without checking every encryption block. Instead, embodiments of the present invention provide that data being encrypted may be sampled at certain rate (which may be constant or varying) and only the sampled data may be checked. Errors rarely appear as completely isolated events; thus, the sampling approach may be useful in detecting many or most errors, even if every encrypted bit is not checked.

Thus, embodiments of the present invention provide for encryption checking hardware that does not need to check all data that is being encrypted and therefore does not need to be as powerful as the actual hardware performing the encryption. As a result the encryption checking hardware may be more cost efficient and dissipate less power than those of existing systems.

In some embodiments, the iterative encryption module 210 may be used to check encryption. As noted above, the module 210 may already be present in many existing HBAs and, for some HBAs, may not even be used while the pipelined module is performing encryption. Thus, some embodiments may provide for encryption checking without even necessitating an additional encryption checking arithmetic circuit (only various control and comparison circuits may need to be added).

The speed of the iterative encryption module may be a fraction of that of the pipelined module (in the example provided, it may be 1/16^{th} of the speed of the pipelined module). Thus, the iterative encryption module may sample incoming data at a ratio associated with that difference in speed (e.g., it may sample every 16^{th} block of data). It may then encrypt the data and compare it with data encrypted by the pipelined module from the same sample. If there is a match, the pipelined module is operating properly. If there is no match, an error message may be issued. Incoming data may be data that is being sent to the pipelined encryption module for encryption.

To further improve the frequency of sampling (and thus improve the chance of catching an error), the iterative decryption module 220 can also be used for checking the encryption of the pipelined encryption module 200. The iterative decryption module may sample incoming data at different points in time than the iterative encryption module, so that their operations are not duplicated. Incoming data sampled by (or for) the iterative decryption module may be stored in a register. The iterative decryption module may then sample encrypted data produced by the pipelined encryption module at a predefined time so that the sampled encrypted data corresponds to the sampled incoming data stored in the register. The decryption module may then decrypt the sampled encrypted data to obtain decrypted data and compare it with the sampled incoming data stored at the register. Again, if there is no match an error message may be issued.

Thus, in the present example, if both the iterative encryption and decryption modules are used for encryption checking, the encryption of one of each eight frames can be checked

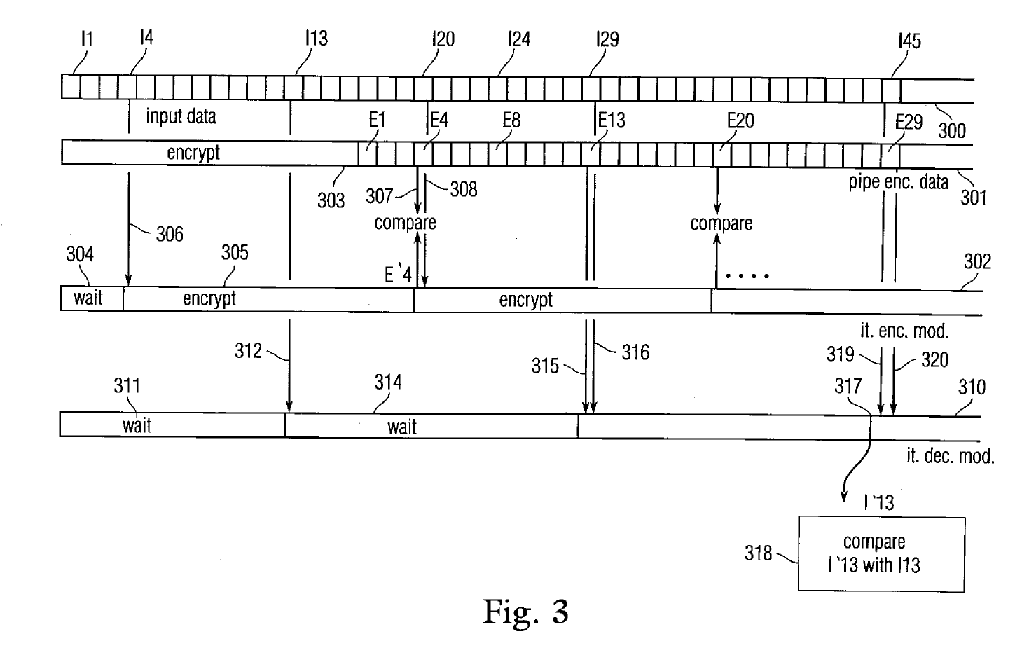

FIG. 3 is a timing diagram of an exemplary encryption checking system of some embodiments of the present invention. Band 300 may represent the input data, or the data that is being input into the pipeline encryption module. Band 301 may represent the encrypted data that is being output by the pipeline encryption module. Each cell may represent a particular data block, with input (or unencrypted) data blocks being referenced using the letter “I” and output blocks being referenced by the letter E (for encrypted). Two blocks having the same number are associated. Thus, for example, block E1 is the encrypted version of input block I1. Input data may be input in the pipeline module at a rate of one block per cycle, so each cell in band 300 may also represent a clock cycle.

As was the case for the above discussed examples, the pipeline module may require 16 clock cycles to encrypt a block of data. Thus, the first block of data I1 may be processed for 16 clock cycles in order to obtain and output an encrypted version of that block (E1). During that time (period 303) the pipelined module may perform encryption without providing any useful output. Each additional block may also take 16 cycles to process but, due to the pipelined structure of module 200, after the first block is encrypted the pipeline encryption module may output a new encrypted block each clock cycle as shown in band 301.

Band 302 may represent the operation of the iterative encryption module. Initially, the iterative encryption module may wait for a randomly generated amount of time. The initial wait time may be obtained by generating a random number between zero and the number of clock cycles in the entire encryption period of the iterative encryption module (16 clock cycles, in the present example). In other embodiments, especially if another module(s) is used to perform checking (i.e., if an iterative decryption module is also used, as in the present example), the upper bound of the random number can be smaller. It can, for example, be the result of the division of the encryption period by the number of checking modules used. Thus, in the present case, as there are two modules used for checking, the upper bound can be 8. In some embodiments in which obtaining a random number may be difficult the number may be pseudo random, based on a counter, etc.

Waiting a random period ensures that a certain type of periodic error does not evade the system. For example, if the pipelined module has a bug that may only manifest itself in every sixth encrypted block, and the system always checks each eight block, then the bug may never be discovered.

In the example of FIG. 3, the random generator may return the value 3. Accordingly, the iterative encryption block may wait three clock cycles (period 304). After the wait period, the iterative encryption module may load the next input block (action 306). In this example, this is block I4. The iterative encryption module may then proceed to encrypt the input block I4 during period 305. The iterative encryption model may encrypt block I4 during the same time the pipelined encryption module encrypts it and may take the same amount of time to do it. However, due to its pipelined nature, the pipelined module may be encrypting other blocks in parallel as well, while the iterative encryption module is only encrypting 14. In some embodiments, the times of encryption of the pipelined and iterative encryption modules may not be the same due to various optimizations that may be present in either module and/or other differences.

The encryption performed by the iterative encryption module may result in block E′4. This block may be compared with block E4 provided by the pipelined encryption module in order to determine whether there is an encryption error (action 307). Furthermore, as soon as block E′4 is generated, the iterative encryption module may load the next input block (block I20) in action 308. This block can also be encrypted by both the pipelined and iterative encryption modules and the two resulting blocks can also be compared. Thus, the iterative encryption module can periodically sample blocks, encrypt them and compare the resulting values with blocks encrypted by the pipelined module.

Band 310 may represent the operation of the iterative decryption module. The iterative decryption module may wait for a predefined period after the iterative encryption module samples the first block (period 311). In some embodiments, this period may be calculated as half of the sampling period of the iterative encryption module. Thus, the period may be 8 clock cycles. Thus, a uniform sampling period may be assured. In other embodiments, the period may be based on a random value. For example, the random value may be a value between one and one less the sampling period of the iterative encryption module.

In the example illustrated in FIG. 3, the waiting period may be 8 clock cycles. Thus, the iterative decryption module may wait for a total of 12 clock cycles (12 being the sum of the waiting periods of the iterative encryption module and the iterative decryption module). After waiting, the iterative decryption module may load the next block of input data (block I13) into a register (thus, the iterative decryption module may be associated with a register that can store at least two blocks). In some embodiments, the loading and storing of input data may be performed by circuitry outside of the iterative decryption module.

The iterative decryption module may then wait for block I13 to be encrypted by the pipelined encryption module (period 314). The pipelined encryption module may encrypt block I13 to form encrypted block E13. The iterative decryption module may load encrypted block E13 (action 315). At this time, the iterative decryption module may also load the current incoming block (block I29) in action 316. Block I29 may be stored in a register, while iterative decryption module may begin decryption of block E13. Decryption may proceed to point 317, at which point the iterative decryption block may obtain a decrypted version of block E13 as a result. This result may be referred to as block I′13. Block I′13 can be compared with the initial input block I13 that was stored in a register (action 318). Again, a match would indicate that encryption is proceeding properly and no match would indicate an error.

After point 317, the iterative decryption module may load blocks I45 and E29 (actions 319 and 320, respectively). Block I45 can be stored in the register (it may replace block I13) and block E29 can be decrypted. Eventually the decrypted version of block E29 can be compared with block I29 which was stored in a register at step 316. Thus, the iterative decryption module may proceed to check the operation of the pipelined encryption module through decryption until all incoming data is exhausted.

A cache copy of the incoming data may be stored for a predefined (relatively short) period after encryption. Thus, if either iterative module detects an error, the incoming data need not be lost. The short period may be based on how long both iterative modules take to detect an error (it should be noted that, as seen in FIG. 3, the iterative decryption module may take longer than its encryption counterpart).

It should be noted that embodiments of the present invention do not assure that all encryption errors will be detected. Thus, an error condition generated by the present embodiments may need to be handled more seriously than by a simple encryption retry. Furthermore, the cache may be stored for a longer time that would initially appear necessary, because an error detected for a certain block may indicate that other errors may have been present during the encryption of previous blocks.

It should be noted that FIG. 3 illustrates the operation and timing of only some exemplary embodiments. It would be evident to those of skill in the art that other embodiments may also exist. For example, the system described above in connection with FIG. 5 is one in which all modules (the pipeline module, the iterative encryption module and the iterative decryption module) process (i.e., encrypt or decrypt) a block in the same time. While the pipelined module does feature a higher throughput it still processes each individual block in the same time as the iterative modules (i.e., 16 clock cycles). This need not be the case. Other embodiments of the present invention may feature different modules that take different amounts of time to process (encrypt or decrypt) blocks of data. If that is the case, a system or method similar to that of FIG. 3 may still be implemented. However, various blocks may need to be temporarily stored to make up for the differences in speeds of processing.

For example, if the iterative encryption block finishes encrypting block I4 after the pipelined module does (e.g., if the iterative encryption module produces block E′4 when the pipelined module produces block E8), then block E4 may be temporarily saved after being generated by the pipelined module. Once the iterative module produces block E′4 then the latter may be compared to the saved version of block E4. The iterative encryption module may then start encrypting the current incoming block (i.e., block I24).

In some embodiments, delays may be occasionally added to the operation of the iterative encryption and/or decryption modules. These may be relatively small delays that may be of random length and/or time of occurrence. These delays may be used to ensure that a periodic error in the operation of the pipelined encryption module does not evade the blocks which the iterative encryption and/or decryption modules check.

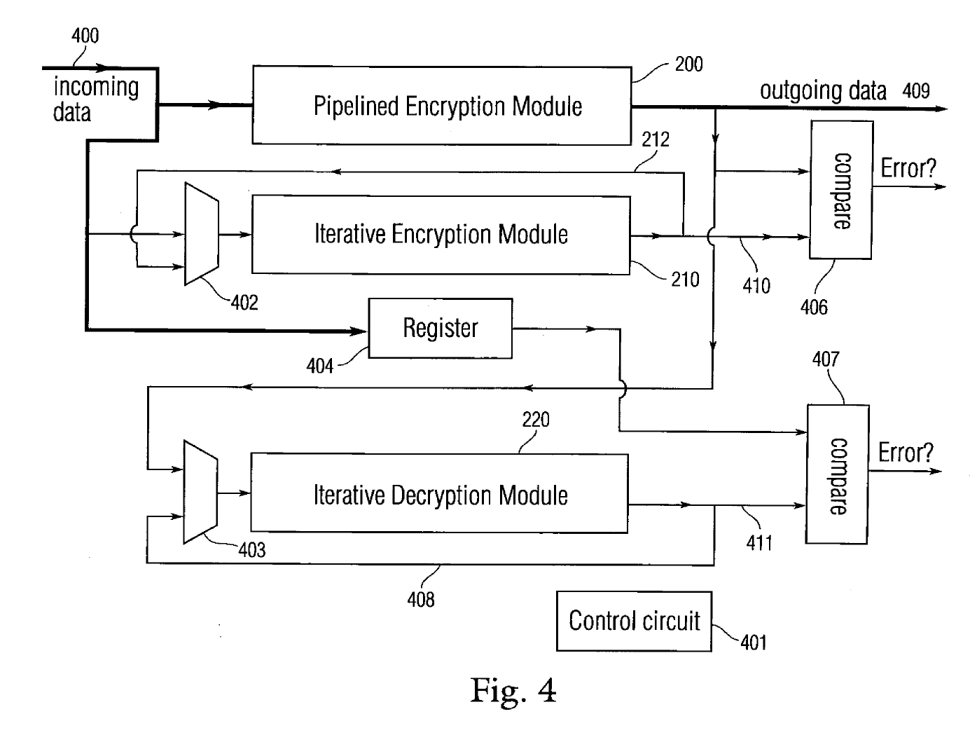

FIG. 4 is a diagram of an exemplary encryption engine according to some embodiments of the invention. The engine of FIG. 4 may be the same or similar to the engine of the conceptual diagram of FIG. 2. FIG. 4 shows some additional implementation details.

Incoming data may enter the engine through link 400. It may directly enter the pipelined encryption module 200 which may encrypt it to produce encrypted outgoing data 409 (i.e., the data represented by band 301 of FIG. 3).

A data input of the iterative encryption module 210 may be connected to multiplexor (or MUX) 402. MUXs 402 and 403 can be controlled by control circuit 401 (connections between the control circuit and various elements it controls are not shown but may nevertheless be present). When the iterative encryption module is ready to start processing new data, the MUX can connect it to the incoming data of link 400. When the module 210 is processing data, the MUX 402 can connect its input to feedback path 212. Thus, intermediate results of the iterative encryption module may be fed back into its input for further processing. When the output 410 of encryption module 210 is ready, it can be compared with an associated output of pipelined module 200 by comparator 406. This comparison may determine if there is an encryption error. Again, control circuit 401 can control comparator 406 (as well as comparator 407) to ensure that the comparison is only performed when a final encrypted block (instead of an intermediate value) is present at the output of module 210.

Incoming data may be stored at register 404 for the benefit of iterative decryption module 220. Control circuit 401 can control register 404 to ensure that it stores the proper data at the proper time (see the discussion referencing FIG. 3 above regarding which data is to be stored). As noted above, register 404 may be able to store at least two blocks of data.

When it is ready to process data, the iterative decryption module 220 may load a block of encrypted data from the output of the pipelined encryption module 200 and through MUX 403 as controlled by control circuit 401. The decryption module 220 may then process the data in order to decrypt it. During processing, the control circuit can configure MUX 403 to send intermediate results of the decryption module 220 back to its input through feedback circuit 408. Once finished, the decryption module 220 can output a decrypted block of data through its output 411. The decrypted block can be compared with an associated previously stored unencrypted block of incoming data from register 404 by comparator 407. The comparator can issue an error code based on the comparison. Again, the control circuit can control the comparator to ensure it does not issue error codes based on comparisons of intermediate results issued by block 220.

FIG. 4 need not feature all circuits and elements of the encryption engine. As recognized by those of skill in the art, additional (and/or different) circuits and elements may be present to implement the functionalities discussed herein.

The embodiments of the present invention discussed above include an iterative encryption and decryption circuits because (as discussed above) these circuits are often present in the encryption engines of existing HBAs in addition to the pipelined decryption circuit. However, embodiments of the present inventions are not limited to the above setup. For example, in addition to the pipelined encryption circuit, embodiments may include a single iterative encryption circuit only, a single iterative decryption circuit only, two or more iterative encryption circuits, two or more iterative decryption circuits, or a combination of one or more iterative encryption circuits with one or more iterative decryption circuits. Embodiments of the invention need not be limited to circuits and modules already provided in existing HBAs, but may include circuits and modules that are added for the purposes of the present invention.

The iterative modules need not be completely iterative. They may include some pipelining but they may be nevertheless slower than the pipelined modules.

More generally, while embodiments are described in terms of pipelined circuits in combination being checked by iterative circuits this need not be the case. In general, embodiments of the present inventions are applicable to a fast encryption circuit that may encrypt an entire stream of incoming data into a stream of encrypted data and one or more slower (or slow) encryption circuit and/or one or more slow decryption circuit that operate(s) only on selected samples of the incoming or encrypted data in order to check the encryption of the fast circuit.

The fast encryption module may be fast due to higher throughput only (as is the case for the pipelined module), or it may also feature higher speed of processing of individual blocks. The fast encryption circuit need not be pipelined.

Thus a slow encryption circuit may select samples of the incoming data, encrypt them to produce secondary encrypted samples and compare the produced secondary encrypted samples with samples of the data stream encrypted by the fast circuit (primary encrypted samples) to determine if there is an encryption error. The primary encrypted samples may be encrypted versions of the samples of the incoming data stream that were initially selected by the fast circuit. A slow decryption circuit may select samples of data blocks from the incoming data stream. It may then select the encrypted data blocks from the data stream encrypted by the fast circuit which correspond to the samples selected from the incoming data stream. It may then decrypt the selected encrypted data blocks to produce secondary decrypted data blocks and compare them with selected samples from the incoming data stream (which may also be referred to as the primary decrypted (or unencrypted) samples). Other features discussed above in connection with pipelined and iterative modules (such as randomizing of start times, spacing of sample points of different modules, etc.) may also be included in the more general fast and slow module embodiments. When multiple checking modules are used, they may be configured so that they do not sample the same data blocks, and/or so that their sampling is spaced out in even intervals.

Fast modules may also be referred to as primary modules and slow modules as secondary. The secondary modules need not be slow in a general sense, just slower than the primary ones.

As noted above, embodiments of the invention need not be limited to HBAs. They may be implemented in various different devices, such as host computers, controllers, telecommunications equipment, mobile telephones and other mobile electronic devices (e.g., PDAs, email devices, etc.), bank machines, etc.

While the above discussed embodiments center on hardware, other embodiments of the present invention may be directed to software or hardware in combination with software. For example, a fast software encryption module may encrypt a data stream and one or more slow software encryption modules and/or one or more slow software decryption modules may be used to check the encryption according to the above discussed methods. Some software modules may be slow and other fast, due to the hardware they execute on. Thus, for example, the fast module may execute at a faster processor of a multiprocessor machine, or a faster core of a multi-core machine, while the slow module(s) may execute at a slower processor and/or core. Alternatively, the slower modules may execute at the same or similar processor(s) or core(s) but may operate at lower priority levels than the fast module.

While the above discussed embodiments of the invention are described in connection with checking encryption other embodiments may center on checking decryption. Thus, the encryption engine may be a decryption engine, the pipelined encryption module may be a pipelined decryption module, the iterative encryption module may be an iterative decryption module, and the iterative decryption module may be an iterative encryption module. In the more general case, a fast encryption module may be substituted by a fast decryption module, a slow encryption module may be substituted by a slow decryption module and a slow decryption module may be substituted by a slow encryption module. A person of skill in the art would recognize that if the above substitutions are performed, decryption based embodiments of the present invention may be described by substantially the same discussion provided above in connection with encryption based embodiments.

As discussed above, embodiments of the present invention need not be limited to particular encryption standards or protocols. For example, embodiments may use the following encryption standards: AES_GCM, AES_XTS, AES_CBC, AES_CTR, AES key wrap unwrap, GMAC, CMAC, DES, etc. In general, all block ciphers may be usable with embodiments of the present invention. While the more detailed examples above concern ciphers that are pipeline-able (i.e., ciphers that provide for multiple applications of the same function), embodiments of the invention are not limited to such ciphers. Non-pipeline-able ciphers may also be used as long as a fast encryption module and a slow encryption (or decryption) module are available or can be created for these ciphers.

Although the present invention has been fully described in connection with embodiments thereof with reference to the accompanying drawings, it is to be noted that various changes and modifications will become apparent to those skilled in the art. Such changes and modifications are to be understood as being included within the scope of the present invention as defined by the appended claims.

What is claimed is:

1. A method of performing and checking encryption comprising:
encrypting an incoming stream of data by a primary encryption module to produce a resulting encrypted stream of data;
sampling a first set of one or more data blocks from the incoming stream of data;
encrypting the one or more sampled data blocks of the first set by a secondary encryption module to produce one or more secondary encrypted data blocks;
selecting a first set of one or more primary encrypted data blocks from the stream of encrypted data, the primary encrypted data blocks of the first set being encrypted versions of the sampled data blocks of the first set; and
comparing the primary encrypted data blocks with the secondary encrypted data blocks to determine whether there has been an error in the encryption of the incoming stream of data,
wherein the primary encryption module has a higher throughput than the secondary encryption module, and the first set of sampled data blocks do not comprise the entire incoming stream of data.

2. The method of claim 2, wherein the sampling includes periodically sampling data blocks.

3. The method of claim 2, wherein the period of sampling is related to the relationship between the throughputs of the primary and secondary encryption modules.

4. The method of claim 2, further including delaying the sampling for a randomly derived period of time.

5. The method of claim 1, wherein the primary and secondary encryption modules are hardware modules.

6. The method of claim 5, wherein the primary encryption module is a pipelined encryption module and the secondary encryption module is an iterative encryption module.

7. The method of claim 1, wherein the primary encryption module encrypts each individual block of data faster than the secondary encryption module.

8. The method of claim 1, further comprising:
sampling a second set of one or more data blocks from the incoming stream of data;
selecting a second set of one or more primary encrypted data blocks from the stream of encrypted data, the primary encrypted data blocks of the second set being encrypted versions of the sampled data blocks of the second set;
decrypting the primary encrypted data blocks of the second set by a secondary decryption module to produce one or more decrypted data blocks; and
comparing the one or more decrypted data blocks with the one or more sampled data blocks of the second set to determine whether there has been an error in the encryption of the incoming stream of data,
wherein the primary encryption module has a higher throughput than the secondary decryption module, and the second set of sampled data blocks do not comprise the entire incoming stream of data.

9. The method of claim 8, wherein the first and second sets of sampled data blocks, when combined, do not comprise the entire incoming stream of data.

10. The method of claim 8, wherein the sampling of data blocks of the second set includes periodically sampling data blocks, the period being related to the relationship between the throughputs of the primary encryption and secondary decryption modules.

11. The method of claim 8, wherein the primary encryption module is a hardware pipelined encryption module, the secondary encryption module is a hardware iterative encryption module and the secondary decryption module is a hardware iterative decryption module.

12. The method of claim 8, wherein the first and second sets of sampled data blocks do not include any common data blocks.

13. A method of performing and checking encryption comprising:
encrypting an incoming stream of data by a primary encryption module to produce a resulting encrypted stream of data;
sampling one or more data blocks from the incoming stream of data;
selecting one or more primary encrypted data blocks from the stream of encrypted data, the primary encrypted data blocks being encrypted versions of the sampled data blocks;
decrypting the primary encrypted data blocks by a secondary decryption module to produce one or more decrypted data blocks; and
comparing the one or more decrypted data blocks with the one or more sampled data blocks to determine whether there has been an error in the encryption of the incoming stream of data,
wherein the primary encryption module has a higher throughput than the secondary decryption module, and the sampled data blocks do not comprise the entire incoming stream of data.

14. A method of performing and checking decryption comprising:
decrypting an incoming encrypted stream of data by a primary decryption module to produce a resulting decrypted stream of data;
sampling one or more data blocks from the incoming stream of data;
decrypting the one or more sampled data blocks by a secondary decryption module to produce one or more secondary decrypted data blocks;
selecting one or more primary decrypted data blocks from the stream of decrypted data, the primary decrypted data blocks being decrypted versions of the sampled data blocks; and
comparing the primary decrypted data blocks with the secondary decrypted data blocks to determine whether there has been an error in the decryption of the incoming stream of data,
wherein the primary decryption module has a higher throughput than the secondary decryption module, and the sampled data blocks do not comprise the entire incoming stream of data.

15. A system of performing and checking encryption comprising:
an interface configured to receive an incoming stream of data;
a memory connected to the interface and configured to store the incoming stream of data;
a primary encryption module connected to the memory and configured to encrypt the stored incoming stream of data to produce a resulting encrypted stream of data;
a secondary encryption module connected to the memory and configured to
sample a first set of one or more data blocks from the stored incoming stream of data, and
encrypt the one or more sampled data blocks of the first set to produce one or more secondary encrypted data blocks; and
a comparator connected to the primary and secondary encryption modules and configured to
select a first set of one or more primary encrypted data blocks from the stream of encrypted data, the primary encrypted data blocks of the first set being encrypted versions of the sampled data blocks of the first set, and
compare the primary encrypted data blocks with the secondary encrypted data blocks to determine whether there has been an error in the encryption of the incoming stream of data,
wherein the primary encryption module has a higher throughput than the secondary encryption module, and the first set of sampled data blocks do not comprise the entire incoming stream of data.

16. The system of claim 15, further comprising a controller which controls the sampling of the secondary encryption module and the selecting of the comparator.

17. The system of claim 15, wherein the sampling includes periodically sampling data blocks.

18. The system of claim 17, wherein the period of sampling is related to the relationship between the throughputs of the primary and secondary encryption modules.

19. The system of claim 17, wherein the secondary encryption module is further configured to delay the sampling for a randomly derived period of time.

20. The system of claim 15, wherein the primary encryption module is a pipelined encryption module and the secondary encryption module is an iterative encryption module.

21. The system of claim 15, wherein the primary encryption module encrypts each individual block of data faster than the secondary encryption module.

22. The system of claim 15, further comprising:
a secondary decryption module connected to the primary encryption module and configured to
sample a second set of one or more data blocks from the incoming stream of data and store the second set of sampled data blocks in the memory;
select a second set of one or more primary encrypted data blocks from the stream of encrypted data, the primary encrypted data blocks of the second set being encrypted versions of the sampled data blocks of the second set, and
decrypt the primary encrypted data blocks of the second set to produce one or more decrypted data blocks; and
a second comparator connected to the secondary decryption module and the memory element and configured to compare the one or more decrypted data blocks with the one or more sampled data blocks of the second set to determine whether there has been an error in the encryption of the incoming stream of data,
wherein the primary encryption module has a higher throughput than the secondary decryption module, and the second set of sampled data blocks do not comprise the entire incoming stream of data.

23. The system of claim 22, wherein the first and second sets of sampled data blocks, when combined, do not comprise the entire incoming stream of data.

24. The system of claim 22, wherein the memory element is configured to periodically sample data blocks, the period being related to the relationship between the throughputs of the primary encryption and secondary decryption modules.

25. The system of claim 22, wherein the primary encryption module is a pipelined encryption module, the secondary encryption module is a iterative encryption module and the secondary decryption module is a iterative decryption module.

26. The system of claim 22, wherein the first and second sets of sampled data blocks do not include any common data blocks.

27. The system of claim 15, further comprising a host comprising a system bus and an HBA connected to the system bus, wherein:
the interface, primary and secondary encryption modules and the comparator are part of the HBA; and
the interface is a system bus interface.

28. A system of performing and checking encryption comprising:
a memory configured to receive an incoming stream of data;
a primary encryption module connected to the link and configured to encrypt the incoming stream of data to produce a resulting encrypted stream of data;
a secondary decryption module connected to the primary encryption module and configured to
sample one or more data blocks from the incoming stream of data;
select one or more primary encrypted data blocks from the stream of encrypted data, the primary encrypted data blocks being encrypted versions of the sampled data blocks, and
decrypt the primary encrypted data blocks to produce one or more decrypted data blocks; and
a comparator connected to the secondary decryption module and the memory element and configured to compare the one or more decrypted data blocks with the one or more sampled data blocks to determine whether there has been an error in the encryption of the incoming stream of data,
wherein the primary encryption module has a higher throughput than the secondary decryption module, and the second set of sampled data blocks do not comprise the entire incoming stream of data.
